(19) United States
(12) Patent Application Publication
(10) Pub. No.: US 2020/0238346 A1
(43) Pub. Date: Jul. 30, 2020

(54) APPARATUS AND METHOD FOR CLEANING CONTAINERS FOR PRESSURIZED GAS

(71) Applicant: Vacum Sol Montage Aps, Taastrup (DK)

(72) Inventor: Henrik ANDERSEN, Taastrup (DK)

(21) Appl. No.: 15/754,994

(22) PCT Filed: Jul. 1, 2016
(86) PCT No.: PCT/EP2016/065501

§ 371 Date: Feb. 23, 2018

(30) Foreign Application Priority Data
Aug. 25, 2015 (DK) PA 2015 00499

(51) Int. Cl. B08B 9/08; B05B 7/14; B05B 13/06; B24C 3/32

(52) U.S. Cl. CPC B08B 9/0813; B05B 7/1486; B05B 13/0627; B63C 11/22; B08B 9/0826; B24C 3/325; B08B 9/0808

(57) ABSTRACT

Apparatus (100) for cleaning the interior of a gas container (2) for pressurized gas; said apparatus comprising: —a rig (4) comprising container receiving means (6) for suspending said container; —an array (7) of elongate arms (8,8′,8″,8′″), wherein said array (7) of elongate arms comprises: ii) an endoscope (14) comprising in its first end (10) image capturing means (16); and ii) a blasting arm (18) comprising in its first end (10′) a bias ling nozzle (19); wherein said apparatus comprises means (20,20′) for independently moving one or more of said elongate arms (8,8′,8″,8′″), relative to said container receiving means (6), in such a way that the first end (10,10′, 10″,10′″) of said one or more of said elongate arms can be inserted into the interior of a gas container (2), when said gas container is suspended in said rig.

### FIELD OF THE INVENTION

The present invention relates to the technology associated with containers or cylinders for compressed gasses, in particular containers for compressed air for scuba diving.

More specifically, the present invention relates in a first aspect to an apparatus for cleaning the interior of a gas container for pressurized gas. In a second aspect, the present invention relates to use of an apparatus according to the first aspect for inspecting and/or cleaning the interior of a gas container. In a third aspect the present invention relates to a method for inspecting and cleaning the interior of a gas container for compressed air.

### BACKGROUND OF THE INVENTION

Gas containers, such as gas cylinders are used as storing means for a wide range of different gases serving a wide range of different purposes. A gas cylinder is typically made of steel and is having a bottom end comprising a supporting foundation and a top end comprising a treaded opening into which a high pressure valve is mounted by a seal.

Gas cylinders may be used for storing pure chemical elements, such as hydrogen, oxygen, nitrogen, argon, helium, or they may be used for storing chemical compounds comprising a number of different chemical elements. Examples of such compounds of elements are propane, butane, acetylene and carbon dioxide.

Another use of gas cylinders are within the field of storing of inter alia air for human respiration purposes, such as for scuba diving. In scuba diving compressed oxygen is carried in a gas cylinder on the back of the diver. Depending on the intended depth of diving, such gas containers may comprise compressed atmospheric air or various mixtures of oxygen, nitrogen and helium.

Although a diver may often chose to bring with him/her a backup storage tank of oxygen it is of paramount importance in regard of diving safety that the gas container and its valve will function properly. To this end it is important that the inner wall of the gas container is clean not comprising any dust or flakes of oxidized metal, such as rust which may interfere with the high pressure valve or interfere with the downstream breathing valve and thereby in a detrimental way jeopardize the safety of the diver.

In order to avoid such potentially safety problems it is common practice amongst divers to regularly clean the inner surface of the gas container.

Many diving associations even have provisions stipulating that each gas container must be cleaned at least once a year.

Such cleaning may be provided by unscrewing the high pressure valve and fill the inside volume with a mixture of water and an abrasive material, such as sand. Subsequently the gas container, including water and abrasive, may be rotated around its longitudinal axis.

Another cleaning procedure involves washing the inside of a gas container with liquid acid solution. This will remove any surface rust on the inside of the container. However, in case the gas container is made of steel such cleaning procedure will imply etching into the material surface thus creating tiny surface fractures which will eventually serve as a large area foundation for new and subsequent oxidation seeds.

EP 1 992 450 A2 discloses an apparatus for cleaning and de-oxidizing the interior of a gas container. The apparatus comprises a rig for suspending the gas container. When the gas container has been suspended in the rig, an abrasive material is poured into the interior of the container. Subsequently, the rig provides for rotation of the gas container around its longitudinal axis. The rotation will by virtue of the abrasive material provide for an abrasive action exerted on the interior wall of the gas container. The apparatus provides for varying the angle of the longitudinal axis of the gas container, thereby varying the position of abrasive action within the gas container.

DE 196 28 842 A1 discloses a method for cleaning of the interior of a gas container, such as a container for compressed air for diving. The method of DE 196 28 842 A1 comprises at least filling the gas container with an abrasive material and moving the gas container, such as moving the gas container around its longitudinal axis when the gas container is arranged in a horizontal direction.

Although the prior art provides for apparatuses and methods for cleaning the inside of a gas container, the prior art systems do not provide for any documentation as to the quality of the cleaning process.

Furthermore, in case of severe oxidation or other types of fouling of the interior walls of a gas container, the prior art systems may not be able to provide for sufficient cleaning and de-oxidizing.

Accordingly, there is a persistent need for an improved method and apparatus for cleaning the interior walls of a gas container, such as a diver's air container.

It is an objective of the present invention to provide an apparatus and a method that overcomes the deficiencies of the prior art systems and apparatuses for cleaning the interior walls of a gas container.

### BRIEF DESCRIPTION OF THE INVENTION

This objective is fulfilled by an apparatus according to claim 1 and with the use according to claim 23 and with the method according to claim 26. Preferred embodiments are set out in the dependent claims 2-22, 24-25 and 27-34.

Accordingly, the present invention in its first aspect relates to an apparatus for cleaning the interior of a gas container for pressurized gas; said apparatus comprising:
a rig, said rig comprising container receiving means for suspending said container;
an array of elongate arms, each having a first end and a second end;

wherein said array of elongate arms comprising:

i) an endoscope comprising in its first end image capturing means for visual inspection of the interior of said container; and

ii) a blasting arm comprising in its first end a blasting nozzle for abrasive blasting the interior of the container;

wherein said apparatus comprises means for independent moving one or more of said elongate arms of the array of elongate arms, relative to said container receiving means, in such a way that the first end of said one or more of said elongate arms of the array of elongate arms can be inserted into the interior of a gas container, when said gas container being suspended in said rig.

The present invention relates in a second aspect to the use of an apparatus according the first aspect of the present invention for inspecting and/or cleaning the interior of a gas container.

In a third aspect the present invention relates to a method for inspecting and/or cleaning the interior of a gas container for compressed air, said method comprising the steps of:

1) inserting an endoscope into the interior of said container for visually inspecting the interior of said gas container.

2) moving said endoscope comprising an image capturing means relative to said container while capturing images of the interior wall of said container;

3) removing said endoscope from said container;

4) inserting a blasting nozzle into the inside of the interior of said container;

5) blasting an abrasive material through said blasting nozzle onto the interior walls of said container and at the same time moving said blasting nozzle relative to said container so as to clean the interior wall of said container;

6) removing said blasting nozzle from said container;

7) re-inserting an endoscope into the interior of said container;

8) moving said endoscope relative to said container while capturing images of the interior wall of said container;

9) inserting an air nozzle into the interior of said container;

10) blowing compressed air through said air nozzle onto the interior walls of said gas container and at the same time moving said blasting nozzle relative to said container so as to remove loose dust or debris from the interior wall of said container;

11) removing said air nozzle from said container;

12) sealing said gas container with a seal or a cap or a valve.

The present invention in its first, second and third aspect provides for a thorough cleaning of the interior of a gas container and furthermore ensures provision of documentation in the form of images documenting the quality of the cleaning process performed.

This will ultimately result in improved safety while diving and also enhanced confidence of the diver because he or she has been convinced, by visual documentation, of the status, quality and safety of the interior walls of the container for compressed air.

The present invention in its first, second and third aspect may also provide improved cleaning quality of other types of containers used for compressed air, and thus improved purity of the content of such containers.

### BRIEF DESCRIPTION OF THE FIGURES

FIG. 1 is a plan view illustrating one embodiment of an apparatus according to the first aspect of the present invention.

FIG. 2 is an illustration depicting one embodiment of a control system to be used with the apparatus according to the present invention.

### DETAILED DESCRIPTION OF THE INVENTION

The present invention relates in a first aspect to an apparatus for cleaning the interior of a gas container for pressurized gas; said apparatus comprising:
a rig, said rig comprising container receiving means for suspending said container;
an array of elongate arms, each having a first end and a second end;

wherein said array of elongate arms comprising:

i) an endoscope comprising in its first end image capturing means for visual inspection of the interior of said container; and

ii) a blasting arm comprising in its first end a blasting nozzle for abrasive blasting the interior of the container;

wherein said apparatus comprises means for independent moving one or more of said elongate arms of the array of elongate arms, relative to said container receiving means, in such a way that the first end of said one or more of said elongate arms of the array of elongate arms can be inserted into the interior of a gas container, when said gas container being suspended in said rig.

The suspension of a gas container in said rig allows easy inspection by image capturing means and subsequent cleaning of the interior of that container by means of insertion of the endoscope and the blasting arm, respectively. This results in an optimized cleaning of the interior wall of the gas container.

In one embodiment of the first aspect of the present invention, said array of elongate arms further comprises an air blasting arm comprising in its first end an air nozzle for blowing compressed air into the interior of said container.

Providing the apparatus with an air blasting arm will allow dusting off any debris or dust deposited on the interior wall of said container for compressed air.

In one embodiment of the first aspect of the present invention said apparatus further comprises an air compressor for supplying air to said abrasive nozzle and/or to said air nozzle.

An air compressor is a convenient means for providing air to those nozzles.

In one embodiment of the first aspect of the present invention said array of elongate arms further comprises a hot air blowing arm comprising in its first end a hot air nozzle for blowing hot air into the interior of said container.

In one embodiment of the first aspect of the present invention the apparatus further comprises a hot air blowing device.

It may be advantageous to provide hot air into the interior of the container for compressed air prior to sealing it off. Such hot air will upon cooling provide for a vacuum in the interior of the container, thus improving the sealing thereof.

In one embodiment of the first aspect of the present invention said container receiving means for suspending said container is configured for receiving said container in an orientation in which the opening of said container is pointing downward.

Orienting the container in this orientation will allow easy emptying the container from abrasive material, dust and debris.

In one embodiment of the first aspect of the present invention said container receiving means for suspending said container comprises a collar of a resilient material having a central hole for receiving said container.

Providing the collar of a resilient material will ensure a tight and sealed connection in a situation in which vacuum is applied in a cleaning process.

In one embodiment of the first aspect of the present invention said container receiving means for suspending said container comprises one or more brushes for brushing off dust or debris deposited at the inside of the opening end of the gas container upon removing said gas container from the container receiving means.

Such brushes will prevent that any dust or debris is left in the opening of the container for compressed air in the situation in which the container is being removed from the receiving means.

In one embodiment of the first aspect of the present invention said apparatus comprises means for rotating said container relative to said rig.

Such rotating means makes it easier for the respective nozzles to direct air or abrasive material towards every area of the interior wall of a container for compressed air.

In one embodiment of the first aspect of the present invention said first end of said endoscope comprising illumination means for illuminating the interior of said container.

Illumination means will improve image quality of the images captured by the image capturing means.

In one embodiment of the first aspect of the present invention said means for independently moving one or more of said elongate arms of the array of elongate arms, relative to said container receiving means, comprises means for moving said one or more of said elongate arms of the array of elongate arms, relative to the rig.

In one embodiment of the first aspect of the present invention said means for independently moving one or more of said elongate arms of the array of elongate arms, relative to said container receiving means, comprises means for moving said container receiving means relative to the rig.

In one embodiment of the first aspect of the present invention said image capturing means of said endoscope being an electronic image capturing means, such as digital camera means.

Digital camera means provides efficient and inexpensive capturing and storing of images.

In one embodiment of the first aspect of the present invention the apparatus further comprises storage means for electronically storing images captured by said image capturing means.

In one embodiment of the first aspect of the present invention comprises a container for storing an abrasive material, such as silica particles, such as glass particles or sand for use by said blasting nozzle.

In one embodiment of the first aspect of the present invention the apparatus comprises a cartridge for accommodating said array of array of elongate arms, wherein said apparatus comprises means for moving, in a horizontal direction, said cartridge relative to said container receiving means, thereby preparing a specific elongate arm to be inserted into the interior of a gas container.

Such a cartridge makes it easier to shift the use of one elongate arm for another. This is especially the case in a situation in which the apparatus is provided with automated means for shifting elongate arms.

In one embodiment of the first aspect of the present invention the apparatus further comprises a vacuum pump for providing a vacuum in a gas container suspended in said rig.

Such a vacuum pump will aid in removing abrasive material, dust and debris from the interior of the container.

In one embodiment of the first aspect of the present invention the apparatus comprises a vacuum hose connecting said vacuum pump with said container receiving means.

In one embodiment of the first aspect of the present invention said apparatus further comprises means for aligning said apparatus with one or more fix points marked on a gas cylinder.

Such fix points will allow aligning the container with the apparatus with the view to keeping track of specific areas of the interior wall of the container for compressed air, thereby allowing identification of points which repeatedly seem to be more prone to rust or oxidation.

In one embodiment of the first aspect of the present invention said apparatus further comprising data processing means for controlling and/or monitoring and/or documenting the procedures performed by the apparatus.

Such means will allow a thorough and well-documented cleaning of the interior of a container for compressed air.

In one embodiment of the first aspect of the present invention said data processing means is coupled to an input device, such as a alphanumerical keyboard and/or where said data processing means is coupled to a monitor for displaying the set-up and/or status of the apparatus.

In one embodiment of the first aspect of the present invention said apparatus further comprising an interphase being coupled to said data processing means, wherein said interphase is configured for controlling one or more of said means for moving one or more of said elongate arms relative to the container receiving means; said air compressor; said hot blowing device; said means for rotating said container relative to the rig; said illumination means, said vacuum pump and/or for receiving images from said image capturing means.

Such interphase allows fully or semi-automatic control of the apparatus.

The present invention relates in a second aspect to a use of an apparatus according to the first aspect of the present invention for inspecting and/or cleaning the interior of a gas container.

In one embodiment of the second aspect of the present invention, said gas container is an air container for scuba diving.

For safety purposes, the apparatus of the first aspect of the present invention is particularly well-suited for cleaning containers for scuba diving.

In one embodiment of the second aspect of the present invention, the use is performed without including cleaning chemicals which may chemically interact with a steel or aluminum surface of a gas container.

Such use will further improve safety for the diver.

The present invention relates in a third aspect to a method for inspecting and cleaning the interior of a gas container for compressed air, said method comprising the steps of:

1) inserting an endoscope into the interior of said container for visually inspecting the interior of said gas container.

2) moving said endoscope comprising an image capturing means relative to said container while capturing images of the interior wall of said container;

3) removing said endoscope from said container;

4) inserting a blasting nozzle into the inside of the interior of said container;

5) blasting an abrasive material through said blasting nozzle onto the interior walls of said container and at the same time moving said blasting nozzle relative to said container so as to clean the interior wall of said container;

6) removing said blasting nozzle from said container;

7) re-inserting an endoscope into the interior of said container;

8) moving said endoscope relative to said container while capturing images of the interior wall of said container;

9) inserting an air nozzle into the interior of said container;

10) blowing compressed air through said air nozzle onto the interior walls of said gas container and at the same time moving said blasting nozzle relative to said container so as to remove loose dust or debris from the interior wall of said container;

11) removing said air nozzle from said container;

12) sealing said gas container with a seal or a cap or a valve.

In one embodiment of the third aspect of the present invention the method further comprising the step of:

8a) noting areas on the interior wall of said gas container which comprises surface part(s) which need further cleaning; and

8b) re-inserting a blasting nozzle into the inside the interior of said container; and

8c) blasting an abrasive material through said blasting nozzle onto the areas of the interior walls of said container as noted in step 8a).

Such method provides a double abrasive action at certain areas and hence will provide for thoroughly cleaning of the interior wall of the container.

In one embodiment of the third aspect of the present invention the method further comprising the step of:

11a) blowing hot air into the interior of said gas container.

In one embodiment of the third aspect of the present invention the method further comprising the temperature of said hot air is at least 10° C. above ambient temperature, such as a temperature of 30-70° C.

In one embodiment of the third aspect of the present step 5 and/or step 10) is accompanied with applying a vacuum to the interior of said gas container.

The vacuum will provide efficient removal of abrasive material, dust and debris from the interior of the container.

In one embodiment of the third aspect of the present invention the method further comprising the feature in step 2) and/or step 8) of storing the images captured on storage means such as an electronic storage means.

This will provide documentation of the result of the cleaning process.

In one embodiment of the third aspect of the present invention the gas container is an air container for scuba diving.

In one embodiment of the third aspect of the present invention the method is being performed by using an apparatus according to the first aspect of the present invention.

In one embodiment of the third aspect of the present invention the method is performed without using cleaning chemicals which may chemically interact with a steel or aluminum surface of a gas container.

Such a cleaning process will enhance safety for a diver in a case the method is used for claing containers for compressed air for diving.

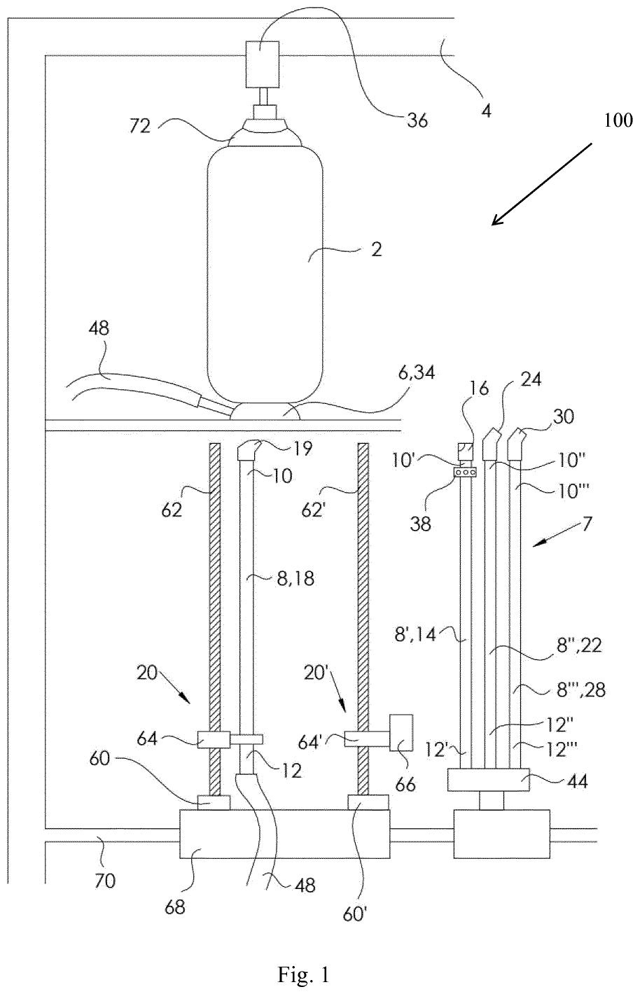

Referring now to the drawings in order to illustrate the present invention, FIG. 1 discloses an apparatus according to the first aspect of the present invention. FIG. 1 shows an apparatus 100. The apparatus is for cleaning the interior of a gas container 2 for pressurized gas, such as a container for compressed air for scuba diving. The apparatus comprises a rig 4, said rig comprising container receiving means 6 for suspending said container. In FIG. 1 the gas container 2 is suspended in an upside-down position in such a way that the opening of the gas container points downward. Before mounting the gas container in the rig, the valve is dismantled from the gas container.

The apparatus comprises an array 7 of elongate arms 8,8′,8″,8′″, each having a first end 10,10′,10″,10′″ and a second end 12,12′,12″,12′″.

The array 7 of elongate arms comprising:

ii) an endoscope 8′,14 comprising in its first end 10′ image capturing means 16 for visual inspection of the interior of said container.

ii) a blasting arm 8,18 comprising in its first end 10 a blasting nozzle 19 for abrasive blasting the interior of the container;

The apparatus comprises means 20,20′ for independent moving one or more of said elongate arms 8,8′,8″,8′″ of the array of elongate arms, relative to said container receiving means 6, in such a way that the first end 10,10′,10″,10′″ of said one or more of said elongate arms of the array of elongate arms can be inserted into the interior of a gas container 2.

In FIG. 1 the means 20 is a means for moving the blasting arm 8,18 relative to said container receiving means 6 comprises an actuator 60 in a form of an electric motor. The axle of the electric motor is coupled to a threaded rod 62. Onto the threaded rod is coupled a bracket 64 in such a way that the threaded rod is engaging an internal thread in said bracket 64.

Connected to the bracket is the blasting arm 8,18. Upon rotating the threaded rod 62, the bracket 64 and hence also the first end 10 of the blasting arm will move up or down. The blasting arm comprises in its first end a blasting nozzle 19. In the second end of the blasting arm 8,18 is connected a hose 48 for supplying compressed air containing an abrasive blasting material.

Also seen in FIG. 1 is the means 20′ for moving one or more of the elongate arms 8′,8″,8′″ relative to said container receiving means 6. The means 20′ comprises an actuator 60′ in a form of an electric motor. The axle of the electric motor is coupled to a threaded rod 62′. Onto the threaded rod is coupled a bracket 64′ in such a way that the threaded rod is engaging an internal thread in said bracket 64′. Connected to the bracket is a gripping mechanism 66.

The gripping mechanism is configured for interchangeable gripping one of the elongate arms 8′,8″ or 8′″.

The elongate arms 8′,8″ or 8′″ being an endoscope 14, an air blasting arm 22 or a hot air blowing arm 28.

In the first end 10′ of the endoscope 8′,14 are arranged image capturing means 16 and illuminating means 38.

In the first end 10″ of the air blasting arm 8″,22 is arranged an air blowing nozzle 24.

In the first end 10′ of the hot air blowing arm 28 is arranged a hot air blowing nozzle 30.

The three arms 8′,14 and 8″,22 and 8′″,28 are arranged in the cartridge 44 which is in the form of a rotatable carrousel. By rotating the cartridge 44 the gripping mechanism 66 may grip the selected and desired elongate arm 8,8″,8′″.

Upon rotating the threaded rod 62′, the bracket 64′ and hence also the first end 10′,10″,10′″ of the selected elongate arm 8′,8″,8′″ will move up or down.

The means 20 and 20′ for moving one or more of the elongate arms 8, 8′,8″,8′″ relative to said container receiving means 6 are both arranged on the slide 68 which is slidable mounted on the rig element 70 of the rig 4.

By sliding the slide 68 to the right or to the left, the elongate arm 8, or 8′,8″,8″ may be arranged in a correct position which allows the arm to be raised into the interior of the gas container 2.

The gas container is supported in the rig 4 by support 72. The support 72 is coupled to the means 36 for rotating container relative to rig. This allows for a thorough inspection and cleaning of all internal sides of the gas container.

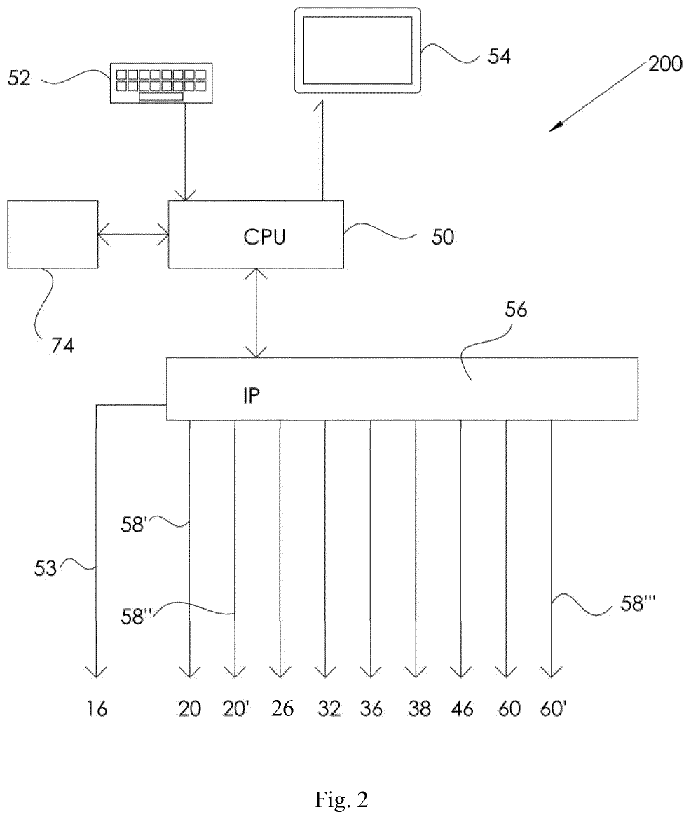

The apparatus may be controlled by means of a control system. The principle of such a control system is outlined in FIG. 2

The control system 200 comprises a data processing unit 50 which is coupled to input means 52 in the form of an alphanumerical keyboard. Also coupled to the data processing unit is a monitor 54 which allows monitoring the setting and performance of the apparatus 100 during use thereof. The monitor and the control unit may also be configured for displaying the images captured by the image capturing means 16 of the endoscope.

The data processing unit 50 is furthermore coupled to a data storage 74 for storing data.

Also coupled to the data processing unit 50 of the control system 200 is an interphase 56. The interphase 56 allows for receiving instructions from the user via the data processing unit 50 and to translate these instructions into signals for controlling one or more of the controllable elements of the Such controllable elements may be apparatus 100 via electric cables 58,58′,58″,58′″.

Such controllable elements may be the image capturing means 16, the means 20,20′ for moving elongate arms relative to the container receiving means, the air compressor 26, the hot air blowing device 32, the means 36 for rotating the container 2 relative to the rig, the illumination means 38, the vacuum pump 46, the means 60 and 60′ for moving the elongate arms relative to the receiver for the gas container. Other controllable elements may be contemplated.

After the valve have been removed from the gas container 2 and the gas container has been suspended in a rig 4 the method for inspecting and cleaning a gas container is as follows:

1) inserting an endoscope 14 into the interior of said container for visually inspecting the interior of said gas container 2.

2) moving said endoscope 14 comprising an image capturing means 16 relative to said container 2 so as to capture images of the interior wall of said container;

3) removing said endoscope 14 from said container;

4) inserting a blasting nozzle 19 into the inside the interior of said container 2;

5) blasting an abrasive material 19 through said blasting nozzle onto the interior walls of said container and at the same time moving said blasting nozzle relative to said container so as to clean the interior wall of said container 2;

6) removing said blasting nozzle 19 from said container;

7) re-inserting an endoscope into the interior of said container 2;

8) moving said endoscope 14 relative to said container 2 so as to capture images of the interior wall of said container;

9) inserting an air nozzle 24 into the inside the interior of said container 2;

10) blowing compressed air through said air nozzle 24 onto the interior walls of said gas container and at the same time moving said blasting nozzle relative to said container 2 so as to remove lose debris from the interior wall of said container 24;

11) removing said air nozzle 24 from said container 2;

12) sealing said gas container 2 with a seal or a cap or a valve.

In a more thorough process, the method may involve the following steps:

1) inserting an endoscope 14 into the interior of said container for visually inspecting the interior of said gas container 2.

2) moving said endoscope 14 comprising an image capturing means 16 relative to said container 2 so as to capture images of the interior wall of said container;

3) removing said endoscope 14 from said container;

4) inserting a blasting nozzle 19 into the inside the interior of said container 2;

5) blasting an abrasive material 19 through said blasting nozzle onto the interior walls of said container and at the same time moving said blasting nozzle relative to said container so as to clean the interior wall of said container 2;

6) removing said blasting nozzle 19 from said container;

7) re-inserting an endoscope into the interior of said container 2;

8) moving said endoscope 14 relative to said container 2 so as to capture images of the interior wall of said container;

8a) noting areas on the interior wall of said gas container) which comprises surface part(s) which need further cleaning; and

8b) re-inserting a blasting nozzle 19 into the inside the interior of said container 2; and

8c) blasting an abrasive material through said blasting nozzle 19 onto the areas of the interior walls of said container and noted in step 8a).

9) inserting an air nozzle 24 into the inside the interior of said container 2;

10) blowing compressed air through said air nozzle 24 onto the interior walls of said gas container and at the same time moving said blasting nozzle relative to said container 2 so as to remove lose debris from the interior wall of said container 24;

11) removing said air nozzle 24 from said container 2;

12) sealing said gas container 2 with a seal or a cap or a valve.

It is preferred that the images captured by the image capturing device 16 of the endoscope 14 are storing on portable electronic storage means 40 such as on an SD card or on a USB memory stick. This will allow a user to have documentation for the cleaning process performed and for the quality status of the cleaned gas container.

### LIST OF REFERENCE NUMERAL

2 Gas container
4 Rig
6 Container receiving means
7 Array of elongate arms
8,8′,8″,8′″ Elongate arms
10,10′,10″,10′″ First end of elongate arm
12,12′,12″,12′″ Second end of elongate arm
14 Endoscope
16 Image capturing means of endoscope
18 Blasting arm
19 Nozzle of blasting arm
20,20′ Means for moving elongate arm relative to container receiving means
22 Air blasting arm
24 Air nozzle of air blasting arm
26 Air compressor
28 Hot air blowing arm
30 Air nozzle of hot air blowing arm
32 Hot air blowing device
34 Collar of container receiving means
36 Means for rotating container relative to rig
38 Illumination means
40 Portable electronic storage means
42 Container for storing an abrasive material
44 Cartridge for accommodating elongate arms
46 Vacuum pump
48 Hose
50 Data processing means
52 Input means
54 Display means
56 Interphase
58,58′,58″,58″,58″ Electric cables
60,60′ Actuator for moving elongate arm relative to container receiving means
62,62′ Threaded rod
64 Bracket
66 Gripping mechanism
68 Slide
70 Rig element
72 Support for gas container
74 Data storage means
100 Apparatus
200 Control system

1. An apparatus for cleaning the interior of a gas container (2) for pressurized gas; said apparatus comprising:
a rig, said rig comprising container receiving means for suspending said container; an array of elongate arms, each having a first end, and a second end;
wherein said array of elongate arms comprising:
ii) an endoscope comprising in its first end image capturing means for visual inspection of the interior of said container; and
ii) a blasting arm comprising in its first end a blasting nozzle for abrasive blasting the interior of the container;
wherein said apparatus comprises means for independent moving one or more of said elongate arms of the array of elongate arms, relative to said container receiving means, in such a way that the first end of said one or more of said elongate arms of the array of elongate arms can be inserted into the interior of a gas container, when said gas container being suspended in said rig.

2. An apparatus according to claim 1, wherein said array of elongate arms further comprises an air blasting arm comprising in its first end an air nozzle for blowing compressed air into the interior of said container.

3. An apparatus according to claim 1 further comprising an air compressor for supplying air to said abrasive nozzle and/or to said air nozzle.

4. An apparatus according to claim 1, wherein said array of elongate arms further comprises a hot air blowing arm comprising in its first end a hot air nozzle for blowing hot air into the interior of said container.

5. An apparatus according to claim 4 further comprising a hot air blowing device.

6. An apparatus according to claim 1, wherein said container receiving means for suspending said container is configured for receiving said container in an orientation in which the opening of said container is pointing downward.

7. An apparatus according to claim 1, wherein said container receiving means for suspending said container comprises a collar of a resilient material having a central hole for receiving said container.

8. An apparatus according to claim 1, wherein said container receiving means for suspending said container comprises one or more brushes for brushing off dust or debris deposited at the inside of the opening end of the gas container upon removing said gas container from the container receiving means.

9. An apparatus according to claim 1, wherein said apparatus comprises means for rotating said container relative to said rig.

10. An apparatus according to claim 1, wherein said first end of said endoscope comprising illumination means for illuminating the interior of said container.

11. An apparatus according to claim 1, wherein said means for independently moving one or more of said elongate arms of the array of elongate arms, relative to said container receiving means, comprises means for moving said one or more of said elongate arms of the array of elongate arms relative to the rig.

12. An apparatus according to, wherein said means for independently moving one or more of said elongate arms of the array of elongate arms, relative to said container receiving means, comprises means for moving said container receiving means relative to the rig.

13. An apparatus according to claim 1, wherein said image capturing means of said endoscope being an electronic image capturing means, such as digital camera means.

14. An apparatus according to claim 13 further comprising an electronic storage means for electronically storing images captured by said image capturing means.

15. An apparatus according to claim 1 further comprising a container for storing an abrasive material, such as silica particles, such as glass particles or sand for use by said blasting nozzle.

16. An apparatus according to any of the preceding claims comprising a cartridge for accommodating said array of array of elongate arms, wherein said apparatus comprises means for moving, in a horizontal direction, said cartridge relative to said container receiving means, thereby preparing a specific elongate arm to be inserted into the interior of a gas container.

17. An apparatus according to claim 1 further comprising a vacuum pump for providing a vacuum in a gas container suspended in said rig.

18. An apparatus according to claim 17 further comprising a vacuum hose connecting said vacuum pump with said container receiving means.

19. An apparatus according to claim 1 further comprising means for aligning said apparatus with one or more fix points marked on a gas cylinder.

20. An apparatus according to claim 1 further comprising data processing means for controlling and/or monitoring and/or documenting the procedures performed by the apparatus.

21. An apparatus according to claim 20, wherein said data processing means is coupled to an input device, such as a alphanumerical keyboard and/or where said data processing means is coupled to a monitor for displaying the set-up and/or status of the apparatus.

22. An apparatus according to claim 20, further comprising an interphase being coupled to said data processing means, wherein said interphase is configured for controlling one or more of said means for moving one or more of said elongate arms relative to the container receiving means; said air compressor; said hot blowing device; said means for rotating said container relative to the rig; said illumination means, said vacuum pump and/or for receiving images from said image capturing means.

23. Use of an apparatus according to claim 1 for inspecting and/or cleaning the interior of a gas container.

24. Use according to claim 23, wherein said gas container is an air container for scuba diving.

25. Use according to claim 23 wherein said use is performed without including cleaning chemicals which may chemically interact with a steel or aluminum surface of a gas container.

26. A method for inspecting and/or cleaning the interior of a gas container for compressed air, said method comprising the steps of:
1) inserting an endoscope into the interior of said container for visually inspecting the interior of said gas container.
2) moving said endoscope comprising an image capturing means relative to said container while capturing images of the interior wall of said container;
3) removing said endoscope from said container;
4) inserting a blasting nozzle into the inside of the interior of said container;
5) blasting an abrasive material through said blasting nozzle onto the interior walls of said container and at the same time moving said blasting nozzle relative to said container so as to clean the interior wall of said container;
6) removing said blasting nozzle from said container;
7) re-inserting an endoscope into the interior of said container;
8) moving said endoscope relative to said container while capturing images of the interior wall of said container;
9) inserting an air nozzle into the interior of said container;
10) blowing compressed air through said air nozzle onto the interior walls of said gas container and at the same time moving said air nozzle relative to said container so as to remove loose dust or debris from the interior wall of said container;
11) removing said air nozzle from said container;
12) sealing said gas container with a seal or a cap or a valve.

27. A method according to claim 26 further comprising the step of:
8a) noting areas on the interior wall of said gas container which comprises surface part(s) which need further cleaning; and
8b) re-inserting a blasting nozzle into the inside the interior of said container; and
8c) blasting an abrasive material through said blasting nozzle onto the areas of the interior walls of said container as noted in step 8a).

28. A method according to claim 26 further comprising the step of:
11a) blowing hot air into the interior of said gas container.

29. A method according to claim 28, wherein the temperature of said hot air is at least 10° C. above ambient temperature, such as a temperature of 30° C.

30. A method according to claim 26, wherein step 10) and/or step 5) is accompanied by applying a vacuum to the interior of said gas container.

31. A method according to claim 26 further comprising the feature in step 2) and/or step 8) of storing the images captured on storage means such as an electronic storage means.

32. A method according to claim 26, wherein said gas container is an air container for scuba diving.

33. A method according to claim 26 performed by using an apparatus.

34. A method according to claim 26 wherein said method is performed without using cleaning chemicals which may chemically interact with a steel or aluminum surface of a gas container.
